(19) United States
(12) Patent Application Publication
(10) Pub. No.: US 2026/0354612 A1
(43) Pub. Date: Nov. 12, 2026

(54) LIQUID HEATING APPLIANCE WITH BYPASS ELECTRICAL POWER SUPPLY CIRCUIT

(71) Applicant: Strix Limited, Ronaldsway, Isle of Man (GB)

(72) Inventors: Raymond Doyle, Ronaldsway (GB); Marc Gibson Collinson, Ronaldsway (GB); Christopher Kay, Ronaldsway (GB); Colin Peter Moughton, Ronaldsway (GB)

(21) Appl. No.: 19/475,287

(22) PCT Filed: Apr. 11, 2024
(86) PCT No.: PCT/GB2024/050950

§ 371 Date: Oct. 14, 2025

(30) Foreign Application Priority Data
Apr. 13, 2023 (GB) 2305458.8
May 12, 2023 (CN) 202310540478.2

(51) Int. Cl. A47J 27/21; H05B 1/02

(52) U.S. Cl. CPC A47J 27/2105; A47J 27/21125; H05B 1/0202; A47J 2202/00; A47J 2203/00

(57) ABSTRACT

A liquid heating appliance comprises a liquid heating vessel, an electrical heater, and a control unit (16). The control unit (16) comprises an adapter part (28) for receiving a supply of electrical power and a first set of (29a, 29b) tabs electrically connected to the adapter part (28) for forming a primary power supply circuit including the heater. A thermomechanical actuator (31) is operable at a predetermined temperature to interrupt the primary power supply circuit. The control unit (16) comprises a second set of tabs (33a, 33b) connected to the adapter part (28), separately from the first set of tabs (29a, 29b), for forming a bypass power supply circuit. The first (29a, 29b) and second set of tabs (33a, 33b) each comprise a tab (29a, 33a) connected to a neutral electrical contact (28c) of the adapter part (28) and a tab (29b, 33b) connected to a live electrical contact (28b) of the adapter part (28).

The present invention relates to a liquid heating appliance.

In liquid heating appliances, such as domestic kettles, an electrical heater is typically arranged to heat liquid stored within a liquid heating vessel of the appliance. Control units may be provided in order to control the provision of electrical power to the electrical heater, e.g. to initiate or terminate a heating operation. Power is typically provided to the liquid heating appliance via a power base connected to a mains supply of electricity.

Said control units often include a switch for removing the supply of electrical power from the appliance when a predetermined temperature is sensed within the appliance, thereby switching off the electrical heater. For example, the control unit may be arranged to disconnect the power supply when the liquid inside the liquid heating vessel has reached boiling, or when an overheat scenario is detected. Typically, control units comprise a thermomechanical element (such as a snap-action bimetallic actuator) that operates at the predetermined temperature to open a switch to interrupt the power supply.

Such thermomechanical elements are advantageous as they are reliable and relatively inexpensive in comparison to electronic temperature detection and actuation means.

However, it is becoming increasingly desirable for liquid heating appliances, in particular domestic appliances, to be provided with additional functionality, including auxiliary components such as electronic display screens or user interfaces. In conventional appliances comprising a thermomechanical control unit, auxiliary electronic components may also be disconnected from the power supply when the predetermined temperature is reached, meaning that these components can only be used while the electrical heater is in operation. This can substantially reduce the usefulness of such domestic appliances.

An existing solution to this problem is to replace the thermomechanical control unit with an electronic control system that senses the temperature of the liquid within the vessel and switches off the electrical heater alone when a predetermined temperature is reached. This can avoid the supply of electrical power to the appliance as a whole being disrupted when the predetermined temperature is detected, with the electrical heater instead being controlled selectively. Such electronic control systems can allow auxiliary components to continue to function even after the electrical heater has been switched off.

However, this solution can dramatically increase the cost and complexity of manufacturing the liquid heating appliance. The present invention seeks to provide a liquid heating appliance that overcomes these problems.

When viewed from a first aspect, the invention provides a liquid heating appliance comprising:
a liquid heating vessel;
an electrical heater for heating liquid contained within the liquid heating vessel; and
a control unit comprising:
   an electrical adapter part for receiving a supply of electrical power;
   a first set of electrical tabs, connected to the electrical adapter part, for electrically connecting to the electrical heater to form a primary electrical power supply circuit;
   a thermomechanical actuator for connecting in series with the primary electrical power supply circuit and operable at a predetermined temperature to interrupt the primary electrical power supply circuit; and
   a second set of electrical tabs, connected to the electrical adapter part separately from the first set of electrical tabs, for electrically connecting to one or more auxiliary components of the liquid heating appliance to form a bypass electrical power supply circuit.

Thus, it will be appreciated that the present invention provides a liquid heating appliance comprising a control unit that includes two separate sets of electrical tabs that are connected to the same electrical adapter part. In some embodiments, the first set of electrical tabs is connected (e.g. directly or indirectly) to the electrical heater to form a primary electrical power supply circuit, which can be interrupted by operation of the thermomechanical actuator at a predetermined temperature (e.g. corresponding to a desired temperature or state of the liquid in the liquid heating vessel, such as boiling). In some embodiments, the second set of electrical tabs is connected to one or more auxiliary components in a bypass electrical power supply circuit. As the second set of electrical tabs is connected to the electrical adapter part separately from the first set of electrical tabs, the bypass electrical power supply circuit can receive the supply of electrical power independently from the primary electrical power supply circuit. The bypass electrical power supply circuit may be connected in parallel with the primary electrical power supply circuit. It will be appreciated, therefore, that operation of the thermomechanical actuator at the predetermined temperature does not interrupt the bypass electrical power supply circuit, meaning that the one or more auxiliary components connected to the bypass electrical power supply circuit can be provided with electrical power even after the thermomechanical actuator has disconnected the electrical heater from the power supply.

This means that a liquid heating appliance can be provided with the functionality of an electronically-controlled kettle, but without necessarily requiring expensive electronic components and complex manufacturing.

The liquid heating appliance preferably comprises a spout arranged in fluid communication with the liquid heating vessel, thereby allowing the contents of the liquid heating vessel to be dispensed. The appliance may comprise a lid, arranged to close an aperture for filling the liquid heating vessel with liquid to be heated. In some embodiments, the liquid heating appliance comprises a handle for lifting the liquid heating appliance.

In some embodiments, the electrical heater comprises an electrical heating element, preferably a sheathed electrical heating element. The electrical heating element may be of a conventional ‘horseshoe’ construction with an electrical termination at either end. The electrical heater may comprise a heat diffuser plate. The electrical heating element may be mounted on the underside of the heat diffuser plate. Preferably the electrical heating element is arranged in thermal communication with the heat diffuser plate. The heat diffuser plate is preferably arranged to heat the contents of the liquid heating vessel. The electrical heater (e.g. including the heat diffuser plate) may be arranged in or beneath a base of the liquid heating vessel.

Preferably the thermomechanical actuator comprises a switch operable to interrupt the primary electrical power supply circuit. The control unit may comprise a trip lever for allowing a user to manually operate the switch. Preferably the switch is arranged to control the supply of electrical power from the electrical adapter part to the electrical heater. The switch may comprise a moveable electrical contact mounted on a movable member. Preferably the switch comprises a fixed electrical contact in the primary electrical power supply circuit. Preferably the moveable electrical contact is arranged to mate with the fixed electrical contact so as to allow electrical power to be supplied to the electrical heater via the primary electrical power supply circuit when the moveable member is in a closed position.

Preferably, at the predetermined temperature, the thermomechanical actuator is configured to move the moveable member from the closed position to an open position wherein the moveable electrical contact is separated from the electrical contact to interrupt the primary electrical power supply circuit.

The thermomechanical actuator may be operable at a predetermined temperature that relates to a change in state, e.g. boiling, of liquid within the liquid heating vessel. Preferably, the thermomechanical actuator is operable at a predetermined temperature that is below 100 °C, for example about 95 °C. Preferably, the thermomechanical actuator is operable at a predetermined temperature that is a steam-sensing temperature. Thus, it will be appreciated that the thermomechanical actuator is not operable to detect overheating of the electrical heater.

Preferably the thermomechanical actuator is arranged to detect steam produced in the liquid heating vessel. In some embodiments, the appliance comprises a steam pipe arranged to direct steam produced in the vessel to reach the thermomechanical actuator in the control unit.

The control unit may further comprise an arrangement for detecting an overheat situation within the liquid heating appliance (e.g. by detecting an overheat temperature of the heat diffuser plate or electrical heater during a “dry-boil” scenario). Said arrangement may comprise a temperature sensor or thermally sensitive actuator, for example a second thermomechanical actuator connected in series with the primary electrical power supply circuit.

The arrangement for detecting an overheat situation within the liquid heating appliance is preferably arranged in (e.g. direct) thermal communication with the heat diffuser plate or the electrical heater.

Preferably the (first) thermomechanical actuator is separate from the arrangement for detecting an overheat situation within the liquid heating appliance. The (first) thermomechanical actuator is preferably not arranged in (e.g. direct) thermal communication with the heat diffuser plate or the electrical heater. The (first) thermomechanical actuator is preferably configured to operate at the predetermined temperature during normal operation of the appliance. However, the arrangement for detecting an overheat situation is preferably configured to operate only as a safety mechanism, rather than during normal operation of the appliance. Preferably the arrangement for detecting an overheat situation is configured to operate at a temperature that is greater than the predetermined temperature at which the (first) thermomechanical actuator is operable to interrupt the primary electrical power supply circuit. Preferably, the arrangement for detecting an overheat situation is configured to operate at a temperature above 100 °C.

The control unit is considered to be novel and inventive in its own right. Thus, when viewed from a second aspect, the invention provides a control unit for a liquid heating appliance, the control unit comprising:
electrical adapter part for receiving a supply of electrical power;
a first set of electrical tabs, connected to the electrical adapter part, for electrically connecting to an electrical heater to form a primary electrical power supply circuit;
a thermomechanical actuator for connecting in series with the primary electrical power supply circuit and operable at a predetermined temperature to interrupt the primary electrical power supply circuit; and
a second set of electrical tabs, connected to the electrical adapter part separately from the first set of electrical tabs, for electrically connecting to one or more auxiliary components to form a bypass electrical power supply circuit.

In embodiments of any aspect disclosed herein, the electrical adapter part may be a cordless electrical adapter part. In some embodiments, the cordless electrical adapter part is arranged to mate with a corresponding base electrical connector part. The cordless electrical adapter part and the corresponding base electrical connector part may be of the type that can be mated regardless of their relative angular orientation, or at least through a wide angular range (e.g. at least 340° and preferably up to 360°). Suitable cordless connectors of this “360° type” are described in WO95/08024 and WO01/28294, and are available as the Strix P72 or P76 connector parts.

In some embodiments, the liquid heating appliance comprises the base electrical connector part. The base electrical connector part may include tabs for electrical connection to a mains power supply cable, or the mains power supply cable may be integrated with the connector part. In embodiments where the control unit comprises a cordless electrical adapter part, the base electrical connector part may be mounted in a power base stand for the liquid heating appliance (i.e. for a cordless appliance removably seated on the power base stand). Preferably the base electrical connector part is not included in an electronic control unit in the power base stand.

Since the control unit in the cordless appliance provides for separate electrical connection to a bypass electrical power supply circuit, this bypass circuit can be used to power electronic control components in the appliance rather than relying on an electronic control in the base stand (as seen e.g. in WO01/28294).

The (e.g. cordless) electrical adapter part may comprise at least two mating conductors, for connecting to live and neutral poles of the base electrical connector part. Thus, preferably the electrical adapter part comprises a neutral electrical contact and a live electrical contact. An additional earth connection may be present. In some embodiments, the electrical adapter part is a 3-pole conductor part (e.g. for mating with a Strix P72 connector). In other embodiments, the electrical connector part is a 5-pole conductor part (e.g. for mating with a Strix P76 connector). Such 5-pole connectors provide for electronic signal connection as well as electrical power connection.

The neutral electrical contact and/or the live electrical contact may comprise a (respective) ring-shaped contact. The ring-shaped contact(s) may be arranged to be received within a (respective) annular aperture in the base electrical connector part.

In some embodiments, a first electrical tab of the first set of electrical tabs is connected to the neutral electrical contact of the electrical adapter part. A second electrical tab of the first set of electrical tabs is preferably connected to the live electrical contact of the electrical adapter part. In some embodiments, the first electrical tab of the first set of electrical tabs is connected to the neutral electrical contact via the switch that is operable by the thermomechanical actuator to interrupt the primary electrical power supply circuit. In some embodiments, the second electrical tab of the first set of electrical tabs is connected to the live electrical contact via the switch.

The electrical heater is preferably connected between the first electrical tab of the first set of electrical tabs and the second electrical tab of the first set of electrical tabs.

Preferably the first set of electrical tabs and/or the second set of electrical tabs are quick-disconnect connectors, e.g. FASTON™ connectors. This can help to reduce the complexity of the process of manufacturing the liquid heating appliance, which can also reduce the cost associated with said manufacturing. In some embodiments, the first set of electrical tabs are directly attached (e.g. welded) to the electrical terminations of the heating element.

In some embodiments, the first set of electrical tabs have a different shape to the second set of electrical tabs.

Preferably the thermomechanical actuator is arranged to detect a temperature representative of a temperature within the liquid heating vessel. The thermomechanical actuator may be arranged to detect steam produced in the liquid heating vessel. For example, the control unit may comprise an arrangement for directing steam that is received from the liquid heating vessel.

The thermomechanical actuator may comprise a bimetallic actuator, preferably a snap-action bimetallic actuator. Where the thermomechanical actuator comprises a switch operable to interrupt the primary electrical power supply circuit, the switch may be operated by movement of the bimetallic actuator. In some embodiments, the thermomechanical actuator may also be arranged to operate (e.g. directly or indirectly) the trip lever of the control unit at the predetermined temperature.

In some embodiments, a first electrical tab of the second set of electrical tabs is connected to the neutral electrical contact of the electrical adapter part. A second electrical tab of the second set of electrical tabs may be connected to the live electrical contact of the electrical adapter part.

In some embodiments, the neutral electrical contact of the electrical adapter part is connected to a first electrical tab of the first set of electrical tabs and to a first electrical tab of the second set of electrical tabs. The live electrical contact of the electrical adapter part may be connected to a second electrical tab of the first set of electrical tabs and to a second electrical tab of the second set of electrical tabs. It will be appreciated therefore that both the primary electrical power supply circuit and the bypass electrical power supply circuit may be connected to the electrical adapter part via the same electrical contacts of the electrical adapter part.

When viewed from a further aspect, the invention provides a control unit for a liquid heating appliance, the control unit comprising: an electrical adapter part for receiving a supply of electrical power, the electrical adapter part comprising a neutral electrical contact and a live electrical contact; a first set of electrical tabs, connected to the electrical adapter part, for electrically connecting to an electrical heater to form a primary electrical power supply circuit; a thermomechanical actuator for connecting in series with the primary electrical power supply circuit and operable at a predetermined temperature to interrupt the primary electrical power supply circuit; and a second set of electrical tabs, connected to the electrical adapter part separately from the first set of electrical tabs, for electrically connecting to one or more auxiliary components to form a bypass electrical power supply circuit; wherein: a first electrical tab of the first set of electrical tabs is connected to the neutral electrical contact of the electrical adapter part and a second electrical tab of the first set of electrical tabs is connected to the live electrical contact of the electrical adapter part; and a first electrical tab of the second set of electrical tabs is connected to the neutral electrical contact of the electrical adapter part and a second electrical tab of the second set of electrical tabs is connected to the live electrical contact of the electrical adapter part.

When viewed from a further aspect, the invention provides a liquid heating appliance comprising: a liquid heating vessel; an electrical heater for heating liquid contained within the liquid heating vessel; and a control unit, the control unit comprising: an electrical adapter part for receiving a supply of electrical power, the electrical adapter part comprising a neutral electrical contact and a live electrical contact; a first set of electrical tabs, connected to the electrical adapter part, for electrically connecting to the electrical heater to form a primary electrical power supply circuit; a thermomechanical actuator for connecting in series with the primary electrical power supply circuit and operable at a predetermined temperature to interrupt the primary electrical power supply circuit; and a second set of electrical tabs, connected to the electrical adapter part separately from the first set of electrical tabs, for electrically connecting to one or more auxiliary components of the liquid heating appliance to form a bypass electrical power supply circuit; wherein: a first electrical tab of the first set of electrical tabs is connected to the neutral electrical contact of the electrical adapter part and a second electrical tab of the first set of electrical tabs is connected to the live electrical contact of the electrical adapter part; and a first electrical tab of the second set of electrical tabs is connected to the neutral electrical contact of the electrical adapter part and a second electrical tab of the second set of electrical tabs is connected to the live electrical contact of the electrical adapter part.

In some embodiments, the liquid heating appliance comprises the one or more auxiliary components, e.g. connected to the second set of electrical tabs to form the bypass electrical power supply circuit. At least one of the auxiliary components may be an electronic component. In various embodiments, the liquid heating appliance comprises the one or more auxiliary components connected to the second set of electrical tabs to form the bypass electrical power supply circuit, wherein the one or more auxiliary components comprises one or more of: a processor, a control circuit, an electronic temperature sensor, a secondary electrical heater, a user interface, an electronic display, a light source, a wireless transceiver, a weight sensor, a fill (e.g. level) sensor, and/or a rechargeable power source.

In some embodiments, the one or more auxiliary components comprises a control circuit. The control circuit may include logic and optionally a processor. In some embodiments, the one or more auxiliary components comprises a processor. The one or more auxiliary components may comprise a memory storing software containing instructions for execution by the processor. The processor is preferably configured to control the operation of one or more others of the auxiliary components. In some embodiments, the one or more auxiliary components preferably comprises a rechargeable power source connected to the processor. This can allow the processor to continue to control one or more auxiliary components after the primary electrical power supply circuit has been interrupted when the appliance is disconnected from the power base.

The one or more auxiliary components may comprise an electronic temperature sensor (e.g. a thermistor), for example arranged to measure (directly or indirectly) the temperature of liquid within the liquid heating vessel. Preferably the electronic temperature sensor is configured to send a measurement signal representative of the temperature of liquid within the liquid heating vessel to the processor. The bypass electrical power supply circuit may therefore include the electronic temperature sensor connected to the processor.

In some embodiments, the one or more auxiliary components comprises a processor and an electronic temperature sensor, wherein the processor is arranged to control one or more further auxiliary components based on a signal received from the electronic temperature sensor. As mentioned above, the one or more auxiliary components preferably comprises a rechargeable power source connected to the processor. This can allow the processor to continue to control the one or more further auxiliary components after the primary electrical power supply circuit has been interrupted when the appliance is disconnected from the power base.

In some embodiments, the one or more auxiliary components preferably comprises an electronic temperature sensor and an electronic display configured to display a temperature value measured by the electronic temperature sensor. For example, the electronic display may be configured to display the current temperature of liquid in the liquid heating vessel as it cools down after a boiling operation. This can beneficially discourage users from re-boiling the liquid when it is not necessary to do so, thereby helping to reduce the negative environmental impact of the device.

In some embodiments, the one or more auxiliary components comprises a secondary electrical heater. The secondary electrical heater preferably has a lower power output than the main electrical heater, e.g. a ‘keep-warm’ heater. In some embodiments, the first set of electrical tabs is connected to the (primary) electrical heater to form the primary electrical power supply circuit and the second set of electrical tabs is connected to a secondary (e.g. lower power) electrical heater.

The secondary electrical heater may be configured to maintain a temperature of liquid within the liquid heating vessel. The liquid heating appliance may comprise a switch arranged to control the supply of electrical power from the bypass electrical power supply circuit to the secondary electrical heater. Operation of the switch is preferably controlled by the processor. The processor may be configured to control the switch in dependence on the measurement signal received from the electronic temperature sensor. The switch may comprise a relay or a triac. The processor may be configured to control the switch in dependence on the value of a timer, e.g. to limit the amount of time in which the ‘keep-warm’ operation of the appliance is active. The processor may be configured to cycle the secondary electrical heater on and off in order to maintain a temperature of the liquid within the liquid heating vessel. The temperature to be maintained may be a predetermined temperature or may be a temperature selected by a user of the liquid heating appliance. The processor may be configured to cycle the secondary electrical heater on and off in response to the measurement signal received from the electronic temperature sensor.

In some embodiments, the one or more auxiliary components comprises a secondary electrical heater arranged to heat liquid contained within the liquid heating vessel, a user interface configured to receive a user input of a target temperature, and a processor arranged to control the secondary electrical heater to heat liquid contained within the liquid heating vessel to the target temperature. In some embodiments the processor may determine a heating time required to reach the target temperature. In some embodiments the processor may control the secondary electrical heater based on a signal received from an electronic temperature sensor. This can provide the liquid heating appliance with an extra heating function even after the primary electrical power supply circuit to the main electrical heater has been interrupted by operation of the thermomechanical actuator. This extra heating function could be used immediately after the main electrical heater (e.g. to lift the liquid temperature up to the target temperature) or at a later time (e.g. to re-heat to the target temperature).

In some embodiments, the one or more auxiliary components comprises a display, preferably an electronic display. In some embodiments, the electronic display is configured to display a countdown timer indicating the time remaining until the liquid contained within the liquid heating vessel reaches a target temperature. The target temperature may be preset or it may be input by a user (e.g. at a user interface as mentioned above). In some embodiments, the processor is configured to turn off the secondary electrical heater automatically after a predetermined time, and the user interface comprises an electronic display configured to display a countdown timer indicating the time remaining before the secondary electrical heater will be turned off automatically by the processor.

In some embodiments, the electronic display is configured to display a volume indication representing the volume of liquid contained within the liquid heating vessel. This can inform users about the amount of liquid present so that only the required volume (e.g. one cup) is heated.

In some embodiments, the one or more auxiliary components comprises a light source or the appliance otherwise comprises a light source connected to the bypass electrical power supply circuit. In some embodiments the one or more auxiliary components comprises a control circuit (optionally comprising a processor) arranged to control the light source. The light source may comprise a light emitting diode (LED) or a plurality of LEDs. The light source is preferably configured to output light of a plurality of different colours. Preferably the colour of light output by the light source is controlled by the processor. The processor may be configured to set the colour of light output by the light source in dependence on a parameter or measurement. For example, the processor may be configured to change the colour of the light source as the temperature of the liquid within the liquid heating vessel increases during heating (e.g. from blue to red), e.g. based on a temperature value measured by an electronic temperature sensor as described above.

In some embodiments, the light source is arranged to project light onto a surface upon which the appliance is positioned, in use. For example, the light source may be arranged to direct light onto the surface of a countertop on which the appliance is placed. In some embodiments, the light source is arranged on the handle of the liquid heating appliance.

In some embodiments, the handle comprises a first portion extending substantially horizontally away from the appliance and a second portion extending from the first portion in a substantially vertical direction towards a base of the appliance. As will be appreciated by those skilled in the art, the first and second portions effectively form an inverted ‘L’ shape, the second portion of which can be gripped by a user. The light source may be arranged on the underside (e.g. the tip) of the second portion of the handle. This placement can help to ensure that the light emitted by the light source is projected onto a surface upon which the liquid heating appliance is placed. It can also help to avoid the light source being obstructed by a user's hand while the liquid heating appliance is being lifted by the user, thereby helping to ensure that the light emitted by the light source remains visible to the user.

In some embodiments, the one or more auxiliary components comprises a user interface. The user interface may be arranged on a side wall of the liquid heating vessel. The user interface preferably comprises input means for operation by a user of the appliance. The input means may comprise one or more of a button, a dial, a touchscreen, or any other suitable or desired means. The user interface may comprise a display, preferably an electronic display. The electronic display may comprise an LCD or an LED (e.g. OLED) display. The electronic display may comprise an electronic display screen. The electronic display screen may comprise a touchscreen display screen, e.g. a resistive or capacitive display screen. This can allow a user to interact with auxiliary components of the appliance such as a processor in order to control the operation of the appliance.

In some embodiments, the display is configured to display a current temperature representative of the temperature of liquid within the liquid heating vessel (e.g. based on a temperature value measured by an electronic temperature sensor as described above). In some embodiments, the display is configured to display a timer indicating an estimate of the time remaining until a target temperature of liquid within the liquid heating vessel is reached. Preferably, the target temperature is selectable by a user via the user interface. The processor is preferably configured to determine said estimate, e.g. using measurements obtained by the electronic temperature sensor. In some embodiments, the display is configured to display the target temperature selected by the user. In some embodiments, the display is configured to display the elapsed time, or the time remaining, of a timer, e.g. a keep-warm timer. In some embodiments, the display is configured to display the time since the liquid within the liquid heating vessel last reached boiling. This can help to reduce the likelihood of a user unnecessarily repeating a boiling operation soon after boiling had occurred (e.g. because they were unaware that boiling had recently been completed). In some embodiments, the display is configured to display an estimate of the volume of liquid present within the liquid heating vessel.

In some embodiments, the display and/or the light source is configured to display one or more alerts to the user. The display/light source may be configured to display an alert informing the user that a descaling operation is required. This can help to reduce the negative environmental impact of the device, as the user can be encouraged to descale the kettle regularly, which can increase the efficiency of the appliance. The display/light source may be configured to display an alert informing the user that the total volume of liquid within the liquid heating vessel is less than a threshold volume. This can help to reduce the risk of a “dry-boil” scenario, in which the appliance may become damaged or may become a safety hazard as a result of the electrical heating element being energised while the liquid heating vessel is empty.

The display/light source may be configured to display usage data to the user. For example, the display may be configured to display environmentally-focussed feedback to the user, e.g. relating to the user's historic operation of the appliance. This can help to “gamify” use of the appliance whilst educating the user in environmentally efficient usage practices.

In some embodiments, the one or more auxiliary components includes a wireless transceiver (e.g. a radio transceiver) for transmitting and receiving data. The display may be configured to display data received by the wireless transceiver.

In some embodiments, the one or more auxiliary components comprises an electronic display and a wireless transceiver for receiving data, wherein the electronic display is configured to display data received by the wireless transceiver. For example, the display may be configured to display weather information, received by the wireless transceiver, to the user via the electronic display. The display may be configured to display email, calendar, time/date, instant message or news data received by the wireless transceiver.

In some embodiments, the one or more auxiliary components comprises an electronic temperature sensor and a wireless transceiver for transmitting data obtained by the electronic temperature sensor. For example, the wireless transceiver may be configured to send usage data measured by the electronic temperature sensor to a remote device or server for processing. The wireless transceiver may be configured to receive processed usage data. As discussed above, the appliance may comprise an electronic display screen configured to display such data to the user, e.g. in the form of environmentally-focussed feedback.

In some embodiments, the one or more auxiliary components comprises a processor and a wireless transceiver for receiving control signals from a remote user for operation of the processor. For example, the wireless transceiver may be configured to receive control signals from a user's personal mobile device which are transmitted to the processor so that one or more other auxiliary components (such as a secondary heater) can be controlled in response to the user's control signals.

In some embodiments, the one or more auxiliary components comprises a sensor for detecting the amount of liquid in the liquid heating vessel. The sensor may comprise a weight sensor for detecting the weight of liquid in the liquid heating vessel. The sensor may comprise a fill level sensor for detecting the volume of liquid in the liquid heating vessel. Preferably the one or more auxiliary components comprises a control circuit and a sensor for detecting the amount of liquid in the liquid heating vessel. Preferably the control circuit is configured to:
determine, using the sensor, a first amount of liquid within the liquid heating vessel when the appliance is positioned on the power base stand;
detect when the appliance has been removed from the power base stand and subsequently placed back on the power base stand; and
after said detection, determine, using the sensor, a second amount of liquid within the liquid heating vessel. Preferably the control circuit is configured to determine whether the difference between the first amount of liquid and the second amount of liquid is less than a threshold. Preferably the control circuit is configured, in response to determining that the difference is less than the threshold, to send a signal for triggering a user-alerting means arranged to alert a user of the liquid heating appliance that an over-fill has occurred. Preferably the control circuit is configured to use the sensor to detect when the appliance has been removed from, and placed back on, the power base stand.

It will be appreciated that the liquid heating appliance may (alternatively or additionally) comprise any of the auxiliary components described herein as part of the primary electrical power supply circuit. However, in preferred embodiments, all of the auxiliary components are connected to the bypass electrical power supply circuit. This allows the auxiliary components to continue to function after the primary electrical power supply circuit has been interrupted by operation of the thermomechanical actuator.

In various embodiments, which can be combined with any of the embodiments described above, the one or more auxiliary components comprises a rechargeable power source. The rechargeable power source may comprise a rechargeable battery. The rechargeable power source may comprise a capacitive power supply. Preferably the rechargeable power source is arranged to provide electrical power to the others of the one or more auxiliary components after the electrical adapter part has been disconnected from the base connector part (e.g. when the cordless liquid heating appliance is lifted away from the power base). Preferably the rechargeable power source is arranged to be charged via the bypass electrical power supply circuit while the electrical adapter part is connected to the base electrical connector part.

This is considered to be novel and inventive in its own right. Thus, when viewed from a third aspect, the invention provides a liquid heating appliance comprising:
a liquid heating vessel;
an electrical heater for heating liquid contained with the liquid heating vessel;
a primary electrical power supply circuit;
a control unit comprising:
   an electrical adapter part for receiving a supply of electrical power, wherein the electrical adapter part is electrically connected to the electrical heater via the primary electrical power supply circuit; and
   a thermomechanical actuator connected in series with the primary electrical power supply circuit and operable at a predetermined temperature to interrupt the primary electrical power supply circuit;
a bypass electrical power supply circuit arranged in parallel with the primary electrical power supply circuit such that operation of the thermomechanical actuator at the predetermined temperature does not interrupt the bypass electrical power supply circuit; and
a rechargeable power supply electrically connected to the electrical adapter part via the bypass electrical power supply circuit.

Thus, this aspect of the invention provides a liquid heating appliance that includes a rechargeable power supply arranged within a bypass electrical power supply circuit of the appliance. The provision of a rechargeable power supply within the bypass electrical power supply circuit allows other electrical components connected to the bypass electrical power supply circuit to receive electrical power even after the electrical adapter part has ceased to receive a supply of electrical power. This may occur when the appliance is disconnected from a mains power supply, e.g. when a user lifts a cordless appliance away from a power base.

As discussed above, one or more auxiliary components may be connected to the bypass electrical power supply circuit to allow the liquid heating appliance to perform additional functions. This aspect of the invention therefore provides a liquid heating appliance that is capable of providing auxiliary electronic features that are typically reserved for only fully-electronic kettles, without requiring the provision of complex electronic components to control operation of the electrical heater.

For example, the provision of a rechargeable power supply can allow an electronic display of the liquid heating appliance to display an estimate of the volume of water present in the liquid heating vessel even when the electrical adapter part is not connected to a supply of electrical power. It will be appreciated that this allows the user to determine the fill level of liquid within the liquid heating vessel using the electronic display while filling the liquid heating vessel (e.g. from a tap), which typically requires the liquid heating appliance to be removed from its power base.

Any of the embodiments described above may exploit the rechargeable power supply in the bypass electrical power supply circuit to supply power to other auxiliary components connected to the bypass electrical power supply circuit. In some embodiments, the liquid heating appliance comprises an electronic temperature sensor and a processor connected to the rechargeable power supply, wherein the processor is arranged to control the one or more auxiliary components based on a signal received from the electronic temperature sensor. In some embodiments, the liquid heating appliance comprises: a secondary electrical heater connected to the rechargeable power supply and arranged to heat liquid contained within the liquid heating vessel; a user interface connected to the rechargeable power supply and configured to receive a user input of a target temperature; and a processor connected to the rechargeable power supply and arranged to control the secondary electrical heater to heat liquid contained within the liquid heating vessel to the target temperature.

In various embodiments, which can be combined with any of the embodiments described above, the one or more auxiliary components comprises an electronic temperature sensor (e.g. a thermistor) arranged to detect the liquid temperature inside the vessel and a display assembly configured to indicate the detected liquid temperature to a user of the appliance. For example, the display assembly may be used to indicate that the liquid temperature has reached the boiling temperature.

When viewed from a yet further aspect, there is provided a liquid heating appliance comprising:
a liquid heating vessel;
an electrical heater for heating liquid contained within the liquid heating vessel; and

a control unit comprising:
an electrical adapter part for receiving a supply of electrical power;
a first set of electrical tabs, connected to the electrical adapter part, for electrically connecting to the electrical heater to form a primary electrical power supply circuit including a set of switch contacts;
a bimetallic actuator operable at a predetermined temperature to interrupt the primary electrical power supply circuit by opening the set of switch contacts; and
a second set of electrical tabs, connected to the electrical adapter part separately from the first set of electrical tabs, for electrically connecting to one or more auxiliary components of the liquid heating appliance to form a bypass electrical power supply circuit.

It will be appreciated that any aspect described herein may (and preferably does) include one or more (e.g. all) of the optional and preferred features outlined herein.

Certain preferred embodiments of the invention will now be described, by way of example only, with reference to the accompanying drawings, in which:

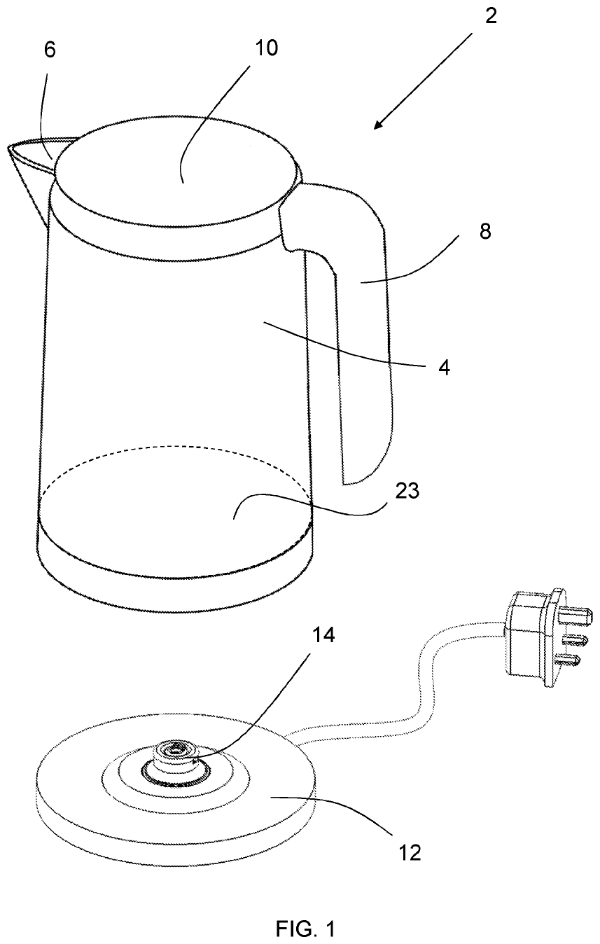

FIG. 1 shows a perspective view of a liquid heating appliance in accordance with an embodiment of the present invention;

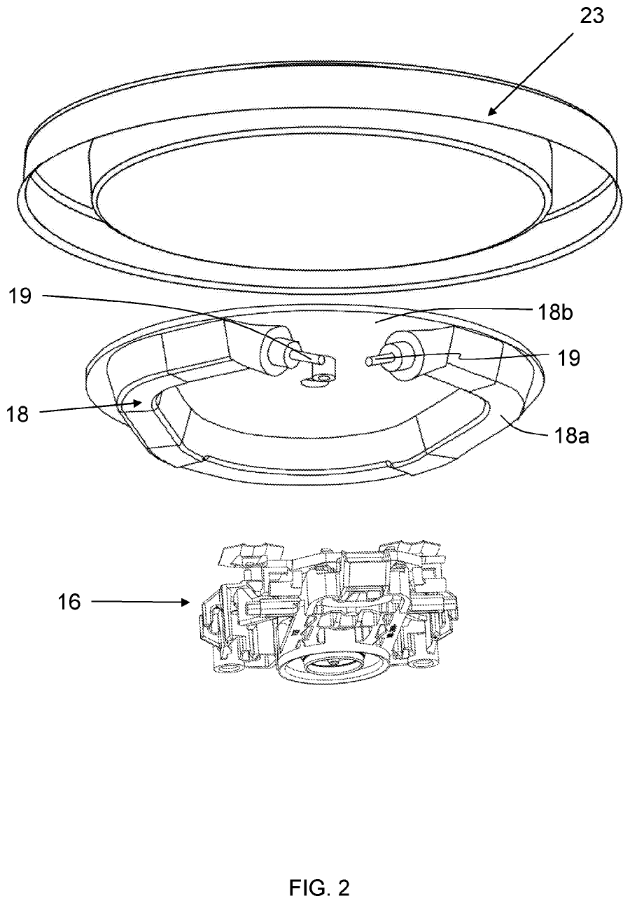

FIG. 2 shows an exploded view of the heating arrangement of the appliance of FIG. 1;

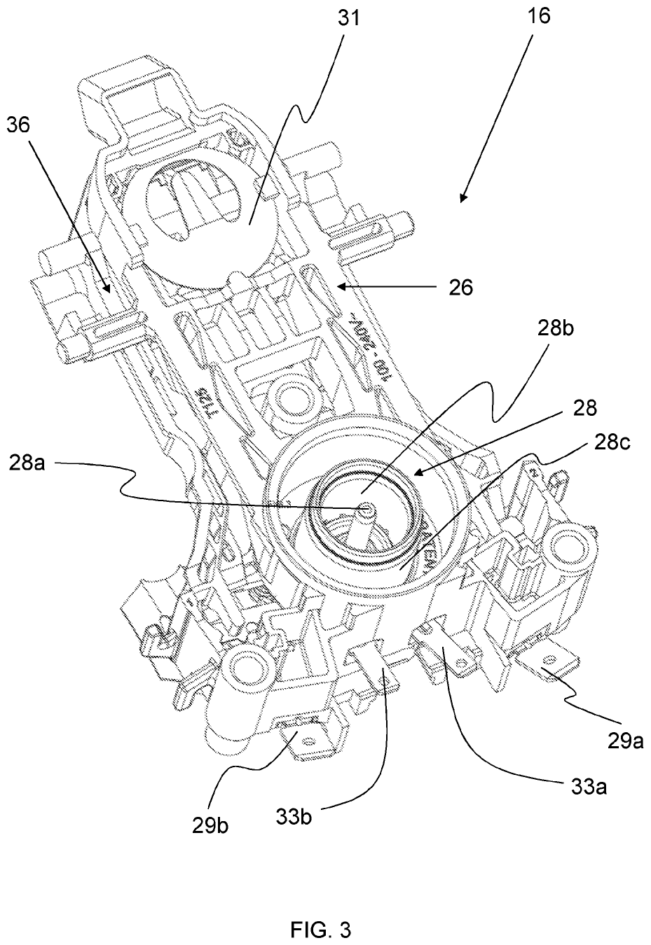

FIG. 3 shows a perspective view of the control unit of the liquid heating appliance of FIG. 1;

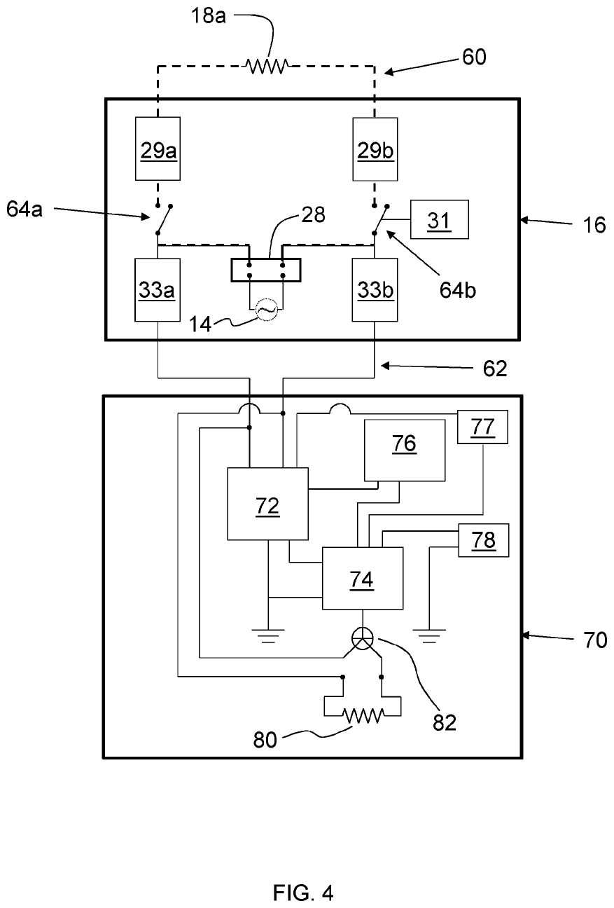

FIG. 4 shows a schematic diagram of the electrical power supply circuits of the liquid heating appliance of FIG. 1;

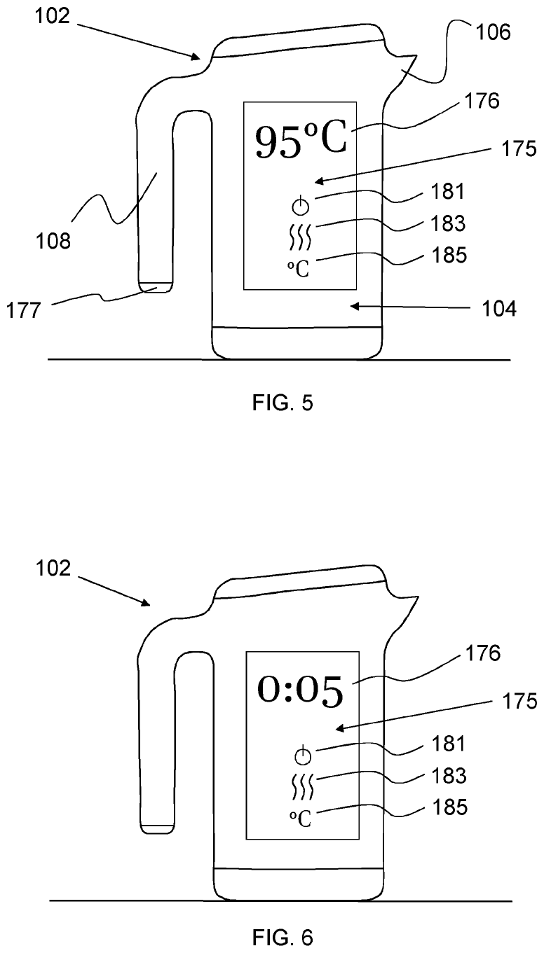

FIG. 5 shows a side view of a liquid heating appliance in accordance with a further embodiment of the present invention;

FIG. 6 shows a side view of the liquid heating appliance of FIG. 5, operating in a further display mode;

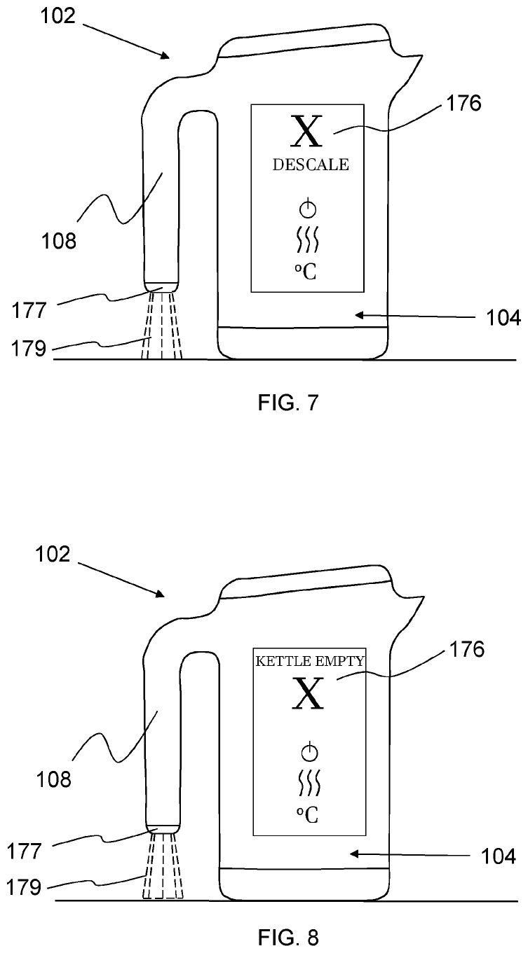

FIG. 7 shows a side view of the liquid heating appliance of FIG. 5, operating in a further display mode;

FIG. 8 shows a side view of the liquid heating appliance of FIG. 5, operating in a further display mode;

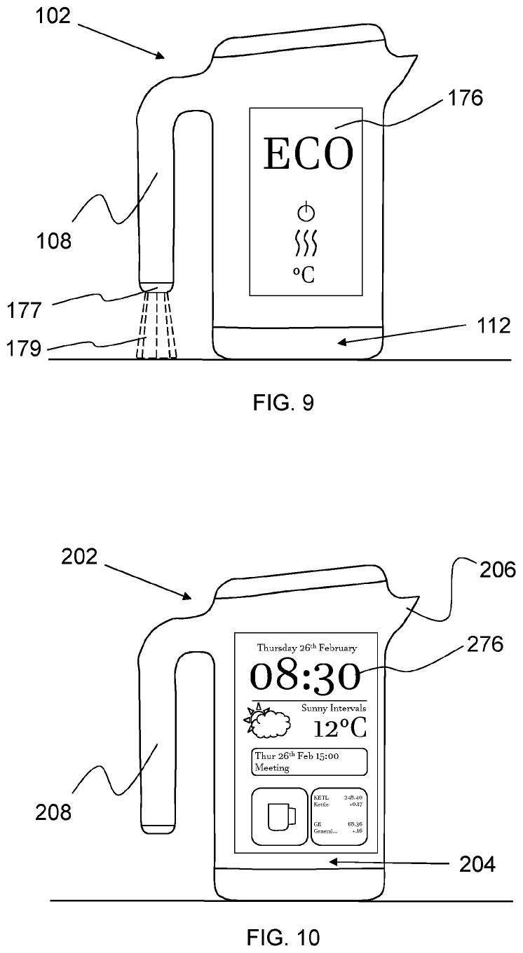

FIG. 9 shows a side view of the liquid heating appliance of FIG. 5, operating in a further display mode;

FIG. 10 shows a side view of a liquid heating appliance in accordance with a further embodiment of the present invention; and

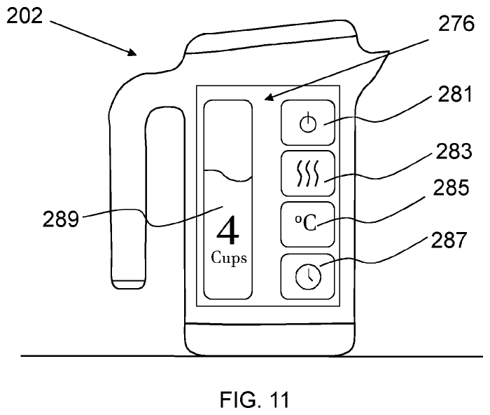

FIG. 11 shows a side view of the liquid heating appliance of FIG. 10, operating in a further display mode.

FIG. 1 shows a perspective view of a liquid heating appliance 2, hereinafter the appliance 2, in accordance with an embodiment of the present invention. The appliance 2 comprises a liquid heating vessel 4, a spout 6 and a handle 8. The top of the appliance 2 is closed with a lid 10.

The appliance 2 is arranged to rest on a power base stand 12 having a 360-degree base electrical connector part 14 provided in the centre for supplying the appliance with electricity.

The appliance 2 further comprises an electrical heater (not shown in FIG. 1) for heating a volume of liquid contained within the liquid heating vessel 4. The heater comprises an electrical heating element mounted to the underside of a heat diffuser plate. The heating element is arranged in conductive thermal communication with the base 23 of the liquid heating vessel 4 via the heat diffuser plate when electrical energy is provided to the heater, thereby heating the contents of the liquid heating vessel 4.

A control unit (not shown in FIG. 1) is also mounted to the underside of the heat diffuser plate, and controls the provision of electrical power from the power base stand 12 to the electrical heater, as described in more detail below.

FIG. 2 shows an exploded view of the heating arrangement of the appliance 2 of FIG. 1, which includes the electrical heater 18, the control unit 16 and the base 23 of the liquid heating vessel 4 of the appliance 2. The other components of the appliance 2 have been removed for clarity. The control unit 16 and the heater 18 are both mounted below the base 23 of the liquid heating vessel 4.

The control unit 16 is arranged to receive the base electrical connector part 14 of the power base 12 and to control the provision of electrical power from the power base stand 12 to the electrical heater 18. The heater 18 comprises a sheathed electrical heating element 18a and a circular heat diffuser plate 18b. The heating element 18a is of a conventional ‘horseshoe’ construction with an electrical termination 19 at either end. The heating element 18a extends substantially around the circumference of the underside of the diffuser plate 18b. The control unit 16 is arranged to be mounted centrally on the underside of the diffuser plate 18b.

FIG. 3 shows a perspective view of the underside of the control unit 16 shown in FIG. 2.

The control unit 16 comprises a moulded plastics body 26 in which there is formed a cordless electrical adapter part 28 on its bottom side. The cordless electrical adapter part 28 is a 3-pole conductor part comprising an earth pin 28a, a live ring 28b, and a neutral ring 28c. The live ring 28b and the neutral ring 28c are concentrically arranged around the central earth pin 28a. The base electrical connector (not shown in FIG. 3) comprises a central aperture to receive the earth pin 28a and a coaxial annular aperture to receive both the live and neutral rings 28b, 28c.

Electrical contacts housed in the central and coaxial apertures contact the live ring 28b and neutral ring 28c respectively to connect the live and neutral poles of the power supply circuit when the connector/adapter parts 14, 28 are brought together.

The control unit 16 comprises a first pair of fixed electrical tabs 29a, 29b, which are electrically connected to the cordless electrical adapter part 28. The neutral tab 29a is connected to the neutral ring 28c, and the live tab 29b is connected to the live ring 28b. Both tabs 29a, 29b are connected to the respective contacts of the cordless electrical adapter part 28 via a switch (not shown in FIG. 3). Each of the first pair of fixed electrical tabs 29a, 29b is further connected via a flying lead (not shown) to a respective electrical termination 19 of the heating element 18a.

The control unit 16 further comprises a thermomechanical actuator 31, supported by the moulded plastics control body 26. The thermomechanical actuator 31 is a snap-action bimetallic actuator set to operate at a predetermined temperature. In use, when the control unit 16 is mounted within the appliance 2, the thermomechanical actuator 31 is arranged to detect the temperature of steam generated by water boiling within the liquid heating vessel 4, e.g. via a steam channel extending from the top of the vessel 4 to the control unit 16 via a steam delivery tube, as is known in the art.

The control unit 16 comprises a trip lever 36 that is pivotally mounted on the control body 26. A distal end of the trip lever 36 is arranged to contact the thermomechanical actuator 31, while a proximal end of the trip lever 36 is arranged to operate the switch (not shown in FIG. 3) that connects the first pair of fixed electrical tabs 29a, 29b with the cordless electrical adapter part 28.

The thermomechanical actuator 31 is arranged such that its operation at the predetermined temperature causes the trip lever 36 to pivot so as to open the switch, thereby disrupting the supply of electrical energy to the first pair of fixed electrical tabs 29a, 29b and, consequently, to the heater 18. This allows the heater 18 to be switched off when a temperature is detected by the thermomechanical actuator 31 that is representative of water within the liquid heating vessel 4 reaching boiling. The trip lever 36 is also manually operable to open and close the switch.

The control unit 16 further comprises a second pair of fixed electrical tabs 33a, 33b. The neutral tab 33a is directly connected to the neutral ring 28c, and the live tab 33b is directly connected to the live ring 28b. In contrast to the first pair of fixed electrical tabs 29a, 29b, neither of the second pair of tabs 33a, 33b is connected to the cordless electrical adapter part 28 via a switch. This means that the second pair of fixed electrical tabs 33a, 33b continues to receive electrical power from the base electrical connector part, via the cordless electrical adapter part 28, even after the thermomechanical actuator 31 has operated to disconnect the heater 18.

Each of the second pair of fixed electrical tabs 33a, 33b can be further connected via a flying lead (not shown) to an auxiliary component module (shown in FIG. 4), thereby providing a bypass electrical power circuit that provides electrical power to the auxiliary component module.

FIG. 4 shows a schematic diagram of the electrical power supply circuits of the appliance 2 of FIG. 1. The appliance 2 comprises a primary electrical power circuit 60 (represented by dashed lines in FIG. 4) and an auxiliary electrical power circuit 62 (represented by solid lines).

As discussed above, the control unit 16 of the appliance 2 comprises a cordless electrical adapter part 28 that can connect to a corresponding base electrical connector part 14, which supplies AC current to the electrical components of the appliance 2 when the appliance 2 is positioned on the power base stand 12 (not shown in FIG. 4). The control unit 16 further comprises a pair of switches 64a, 64b and a first pair of fixed electrical tabs 29a, 29b. Each tab 29a, 29b is connected to the cordless electrical adapter part 28 via a respective one of the switches 64a, 64b.

The electrical heating element 18a is connected across the first pair of tabs 29a, 29b, thereby completing the primary electrical power circuit 60.

The thermomechanical actuator 31 is arranged to open the switches 64a, 64b when the predetermined temperature is sensed. This causes the electrical heating element 18a to be disconnected from the electrical power supply provided by the base electrical connector part 14, thereby turning off the heater 18a.

The control unit 16 further comprises a second pair of fixed electrical tabs 33a, 33b, each connected to the cordless electrical adapter part 28. Unlike the first pair of fixed electrical tabs 29a, 29b, each of the second pair of fixed electrical tabs 33a, 33b is connected directly to the cordless electrical adapter part 28, rather than via a switch.

An auxiliary component module 70 is connected across the second pair of fixed electrical tabs 33a, 33b, thereby completing the auxiliary electrical power circuit 62, which is in parallel with the primary electrical power circuit 60.

Owing to the arrangement described above, when the thermomechanical actuator 31 operates to open the switches 64a, 64b so as to disconnect the electrical heating element 18a from the power source provided by the base electrical connector part 14, the supply of electrical power to the auxiliary electrical power circuit 62 is not disrupted.

In this example, the auxiliary component module 70 comprises a low-cost power source 72 that is directly connected to the second pair of fixed electrical tabs 33a, 33b. The low-cost power source 72 is arranged to store electrical energy received from the power supply of the base electrical connector part 14 when the appliance 2 is arranged on the power base stand 12. This means that, after the appliance 2 has been lifted away from the power base stand 12, such that the cordless electrical adapter part 28 and the base electrical connector part 14 are no longer connected, the low-cost power source 72 can provide electrical power to the other components of the auxiliary component module 70. Therefore, the appliance 2 can be provided with electrical components that can continue to operate even after the appliance 2 has been removed from the power base stand 12, as will be described in more detail below.

The auxiliary component module 70 further comprises a processor 74, a low power electronic display 76, a light-emitting diode (LED) 77, and a thermistor 78, each of which is arranged to receive electrical power from the low-cost power source 72. Although the components of the auxiliary component module 70 are grouped together in the schematic shown in FIG. 4, these components are not necessarily located physically adjacent one another in the appliance 2.

The electronic display 76 is arranged on the side of the liquid heating vessel 4 of the appliance 2, between the handle 8 and the spout 6. The LED 77 is arranged at the end of the handle 8 so as to project light vertically downwards, e.g. towards a surface on which the appliance 2 has been placed. The LED 77 on the handle allows a user to be provided with information relating to the status of the appliance 2 from a greater distance, or when the display 76 is facing away from the user.

The auxiliary component module 70 further comprises a ‘keep-warm’ (i.e. low power) electrical heating element 80 that is connected to the second pair of fixed electrical tabs 33a, 33b via a triac 82 that is controllable by the processor 74. The keep-warm electrical heating element 80 is arranged in the appliance 2 adjacent the base 23 of the liquid heating vessel 4 so that, when the heating element 80 is provided with electrical power, the heat generated by the heating element 80 is used to heat the contents of the liquid heating vessel 4. The thermistor 78 is arranged in the appliance 2 so as to detect a temperature of the contents of the liquid heating vessel 4.

The processor 74 is configured, during a ‘keep-warm’ mode of operation of the appliance 2, to receive temperature measurements form the thermistor 78 and to operate the triac 82 so as to cycle the keep-warm heating element 80 on or off in order to keep the contents of the vessel 4 at a substantially constant desired temperature.

Certain preferred uses of the components of the auxiliary component module 70 will now be described with reference to FIGS. 5 to 11.

FIG. 5 shows an appliance 102 in accordance with a further embodiment of the present invention. The appliance 102 is essentially the same as the appliance of FIG. 1; the module 70 comprises a user interface 175 comprising an electronic display 176, a power button 181, a keep warm selection button 183 and a temperature selection button 185. The user interface 175 is arranged on a side wall of the liquid heating vessel 104 of the appliance 102, between the handle 108 and the spout 106. The electronic display 176 is an LED display arranged beneath a transparent portion of the wall of the liquid heating vessel 104. The appliance 102 further comprises an LED 177 arranged on the underside of the tip of the handle 108 of the appliance 102.

After switching on the appliance 102 using the power button 181, a user of the appliance 102 can select a temperature to which the liquid within the vessel 104 is desired to be heated. The selection is made by pressing the temperature selection button 183 until the desired target temperature is displayed on the display 176, as shown in FIG. 5.

The selected temperature is implemented by the user pressing the power button 181 once again. The display 176 is then configured to display a countdown timer indicating the time remaining until the liquid within the liquid heating vessel 104 reaches the selected temperature, as shown in FIG. 6.

The display 176 may also display the current temperature of the liquid within the liquid heating vessel 104 during the heating operation, regardless of whether the user has selected a target temperature. The current temperature is determined by the processor of the appliance 102 using measurements obtained by a thermistor arranged within the appliance 102 to detect the temperature within the liquid heating vessel 104. The LED 177 on the handle 108 can also output a different colour to indicate the rise in temperature of the liquid in the vessel 104 (e.g. changing gradually from blue to red as the temperature increases from the initial temperature to the target temperature).

If a keep-warm mode of operation is required after the liquid within the liquid heating vessel 104 has been heated to the target temperature, the user presses the keep-warm selection button 183. The user continues to press the button 183 until the desired keep-warm cycle duration is shown by the display 176. The selection is implemented by pressing the power button 181, and the appliance 102 proceeds to maintain the temperature of the liquid at this temperature for the selected keep-warm period.

During the keep-warm mode of operation, the electronic display 176 is used to inform the user of the amount of time remaining before the keep-warm heater of the appliance 102 will be turned off automatically by the processor.

FIG. 7 shows the appliance 102 of FIG. 5, wherein the electronic display 176 is displaying an alert informing a user of the appliance 102 that the appliance 102 needs to be descaled. In this situation, the LED 177 arranged on the handle 108 is configured to output a blue light 179 to provide a further indication to the user that the appliance 102 needs to be descaled. The build-up of limescale in a liquid heating appliance can prolong the time taken for the liquid within the appliance to reach boiling point, thereby increasing the total amount of electrical energy required. Informing a user of when the appliance 102 requires descaling can help to reduce the occurrence of unnecessarily prolonged boil times, thereby reducing the negative environmental impact of the appliance 102.

FIG. 8 shows the appliance 102 of FIG. 5, wherein the electronic display 176 is displaying an alert informing a user of the appliance 102 that the liquid heating vessel 104 is empty. In this situation, the LED 177 on the handle 108 of the appliance 102 is configured to output a red light 179 to provide a further indication to the user that the liquid heating vessel 104 is empty. The display 176 and the LED 177 may also be used to warn the user that a dry-boil event has occurred, i.e. that the control unit of the appliance 102 has disconnected the heating element from the electrical power supply after detecting that the liquid heating vessel 104 is empty (e.g. because all of the liquid that was present in the vessel 104 has been converted into steam).

FIG. 9 shows the appliance 102 of FIG. 5, wherein the electronic display 176 is displaying an alert informing a user of the appliance 102 that the appliance 102 is providing “ECO” feedback to the user. In this mode, environmentally-focussed usage feedback is provided to the user, based on the colour of the light emitted by the LED 177 on the handle 108, when the appliance 102 is placed on the power base stand 112. The LED 177 is configured to output a green light 179 if the user's habitual use of the appliance 102 is determined by the processor of the appliance 102 to be environmentally efficient, and to output a red light 179 if the user's habitual use of the appliance 102 is determined not to be environmentally efficient. In some embodiments, the auxiliary component module 70 of the appliance 102 includes a weight/fill sensor (not shown) that detects the amount of liquid in the liquid heating vessel 104 (i) before the appliance 102 has been removed from the power base stand 112 and (ii) after the appliance 102 has been returned to the power base stand 112 (e.g. after making a beverage). The processor 74 compares the detected values to determine the amount of liquid that has been dispensed from the liquid heating vessel 104, and consequently determines whether the user heated more liquid than they have used (i.e. that they over-filled the appliance). A red light 179 is output when it is determined that the user has (e.g. habitually) over-filled the appliance 102.

This can be used to “gamify” use of the appliance 102 whilst educating the user in environmentally efficient usage practices. This can help to improve the way that users operate the appliance 102 in order to reduce the negative environmental impact of the appliance 102.

FIG. 10 shows a liquid heating appliance 202 in accordance with a further embodiment of the invention. The appliance 202 is essentially the same as the appliance of FIGS. 1 and 5, except the module 70 comprises a touch screen organic light-emitting diode (OLED) display 276 arranged on a side wall of the liquid heating vessel 204 of the appliance 202, between the handle 208 and the spout 206. The appliance 202 is provided with WiFi connectivity, allowing a wide range of data to be retrieved by the appliance 202 and shown to the user via the display 276, including the date and time, the weather forecast, and a user's upcoming appointments in their cloud-based calendar.

The appliance 202 is also configured to transmit data collected by sensors within the appliance 202 to a server or processor via WiFi for further processing or analysis.

As shown in FIG. 11, the appliance 202 is further configured to run applications relating to different modes of operation of the appliance 202, including the temperature selection and keep-warm modes discussed above. The display 276 includes icons corresponding to a power function 281, a keep warm function 283 and a temperature selection function 285. The display 267 also includes an icon corresponding to a timer function 287, which can be used to delay the start of the operation of the appliance 202 by a selected period of time.

The electronic display 276 is also configured to provide a volume indication 289 to the user, representing the volume of liquid currently contained within the liquid heating vessel 204.

What is claimed is:

1. A liquid heating appliance comprising:
a liquid heating vessel;
an electrical heater for heating liquid contained within the liquid heating vessel; and
a control unit comprising:
a cordless electrical adapter part configured to mate with a corresponding base electrical part to receive a supply of electrical power, wherein the cordless electrical adapter part comprises a neutral electrical contact and a live electrical contact;
a first set of electrical tabs, connected to the cordless electrical adapter part, for electrically connecting to the electrical heater to form a primary electrical power supply circuit;
a thermomechanical actuator for connecting in series with the primary electrical power supply circuit and operable at a predetermined temperature to interrupt the primary electrical power supply circuit; and
a second set of electrical tabs, connected to the cordless electrical adapter part separately from the first set of electrical tabs, for electrically connecting to one or more auxiliary components of the liquid heating appliance to form a bypass electrical power supply circuit;
wherein:
a first electrical tab of the first set of electrical tabs is connected to the neutral electrical contact of the cordless electrical adapter part and a second electrical tab of the first set of electrical tabs is connected to the live electrical contact of the cordless electrical adapter part; and
a first electrical tab of the second set of electrical tabs is connected to the neutral electrical contact of the cordless electrical adapter part and a second electrical tab of the second set of electrical tabs is connected to the live electrical contact of the cordless electrical adapter part.

2. (canceled)

3. The liquid heating appliance of claim 1, wherein the first set of electrical tabs and/or the second set of electrical tabs are quick-disconnect connectors.

4. The liquid heating appliance of claim 1, wherein the first set of electrical tabs have a different shape to the second set of electrical tabs.

5. The liquid heating appliance of claim 1, wherein the thermomechanical actuator is operable at a predetermined temperature below 100 °C.

6. The liquid heating appliance of claim 1, wherein the control unit comprises a switch operable to interrupt the primary electrical power supply circuit and a trip lever for allowing a user to manually operate the switch.

7. The liquid heating appliance of claim 6, wherein the thermomechanical actuator is arranged to operate the trip lever at the predetermined temperature.

8. The liquid heating appliance of claim 1, wherein the control unit comprises a switch operable by the thermomechanical actuator to interrupt the primary electrical power supply circuit, and wherein:
the first electrical tab of the first set of electrical tabs is connected to the neutral electrical contact via the switch; and/or
the second electrical tab of the first set of electrical tabs is connected to the live electrical contact via the switch.

9. The liquid heating appliance of claim 1, wherein the liquid heating appliance comprises the one or more auxiliary components connected to the second set of electrical tabs to form the bypass electrical power supply circuit, and wherein the one or more auxiliary components comprises one or more of: a processor, a control circuit, an electronic temperature sensor, a secondary electrical heater, a user interface, an electronic display, a light source, a wireless transceiver, a weight sensor, a fill sensor, and/or a rechargeable power source.

10. The liquid heating appliance of claim 9, wherein the one or more auxiliary components comprises:
a processor; and
an electronic temperature sensor arranged to measure the temperature of liquid within the liquid heating vessel,
wherein the processor is arranged to control one or more further auxiliary components based on a signal received from the electronic temperature sensor.

11. (canceled)

12. The liquid heating appliance of claim 9, wherein the one or more auxiliary components comprises:
an electronic temperature sensor arranged to measure the temperature of liquid within the liquid heating vessel; and
an electronic display configured to display a temperature value measured by the electronic temperature sensor.

13. The liquid heating appliance of claim 9, wherein the one or more auxiliary components comprises:
a secondary electrical heater arranged to heat liquid contained within the liquid heating vessel;
a user interface configured to receive a user input of a target temperature; and
a processor arranged to control the secondary electrical heater to heat liquid contained within the liquid heating vessel to the target temperature.

14-18. (canceled)

19. The liquid heating appliance of claim 9, wherein the one or more auxiliary components comprises an electronic display configured to display a volume indication representing the volume of liquid contained within the liquid heating vessel.

20-23. (canceled)

24. The liquid heating appliance of claim 9, wherein the one or more auxiliary components comprises a light source and a control circuit arranged to control the light source.

25. The liquid heating appliance of claim 24, wherein the light source is arranged to project light onto a surface upon which the appliance is positioned, in use.

26-27. (canceled)

28. The liquid heating appliance of claim 1, wherein the first set of electrical tabs is connected to the electrical heater to form the primary electrical power supply circuit and the second set of electrical tabs is connected to a secondary electrical heater to form the bypass electrical power supply circuit.

29. The liquid heating appliance of claim 1, wherein the one or more auxiliary components comprises a sensor for detecting the amount of liquid in the liquid heating vessel and a control circuit, wherein the control circuit is configured to:
determine, using the sensor, a first amount of liquid within the liquid heating vessel when the appliance is positioned on the power base stand;
detect when the appliance has been removed from the power base stand and subsequently placed back on the power base stand;
after said detection, determine, using the sensor, a second amount of liquid within the liquid heating vessel;
determine whether the difference between the first amount of liquid and the second amount of liquid is less than a threshold; and
in response to determining that the difference is less than the threshold, to send a signal for triggering a user-alerting means arranged to alert a user of the liquid heating appliance that an over-fill has occurred.

30. A control unit for a liquid heating appliance, the control unit comprising:
a cordless electrical adapter part configured to mate with a corresponding base electrical part to receive a supply of electrical power, wherein the cordless electrical adapter part comprises a neutral electrical contact and a live electrical contact;
a first set of electrical tabs, connected to the cordless electrical adapter part, for electrically connecting to an electrical heater to form a primary electrical power supply circuit;
a thermomechanical actuator for connecting in series with the primary electrical power supply circuit and operable at a predetermined temperature to interrupt the primary electrical power supply circuit; and
a second set of electrical tabs, connected to the cordless electrical adapter part separately from the first set of electrical tabs, for electrically connecting to one or more auxiliary components to form a bypass electrical power supply circuit;
wherein:
a first electrical tab of the first set of electrical tabs is connected to the neutral electrical contact of the cordless electrical adapter part and a second electrical tab of the first set of electrical tabs is connected to the live electrical contact of the cordless electrical adapter part; and
a first electrical tab of the second set of electrical tabs is connected to the neutral electrical contact of the cordless electrical adapter part and a second electrical tab of the second set of electrical tabs is connected to the live electrical contact of the cordless electrical adapter part.

31. A liquid heating appliance comprising:
a liquid heating vessel;
an electrical heater for heating liquid contained with the liquid heating vessel;
a primary electrical power supply circuit;
a control unit comprising:
a cordless electrical adapter part configured to mate with a corresponding base electrical part to receive a supply of electrical power, wherein the cordless electrical adapter part is electrically connected to the electrical heater via the primary electrical power supply circuit; and
a thermomechanical actuator connected in series with the primary electrical power supply circuit and operable at a predetermined temperature to interrupt the primary electrical power supply circuit;
a bypass electrical power supply circuit arranged in parallel with the primary electrical power supply circuit such that operation of the thermomechanical actuator at the predetermined temperature does not interrupt the bypass electrical power supply circuit; and
a rechargeable power supply electrically connected to the cordless electrical adapter part via the bypass electrical power supply circuit.

32. (canceled)

33. The liquid heating appliance of claim 31, wherein the liquid heating appliance comprises one or more auxiliary components connected to the rechargeable power supply, wherein the auxiliary components comprise one or more of: a processor, an electronic temperature sensor, a secondary electrical heater, a user interface, and/or an electronic display.

34. (canceled)

35. The liquid heating appliance of claim 31, wherein the liquid heating appliance comprises:
a secondary electrical heater connected to the rechargeable power supply and arranged to heat liquid contained within the liquid heating vessel;
a user interface connected to the rechargeable power supply and configured to receive a user input of a target temperature; and
a processor connected to the rechargeable power supply and arranged to control the secondary electrical heater to heat liquid contained within the liquid heating vessel to the target temperature.

36-40. (canceled)
